(19) United States
(12) Patent Application Publication
(10) Pub. No.: US 2020/0097895 A1
(43) Pub. Date: Mar. 26, 2020

(54) CONTROLLING METHOD OF UNATTENDED RETAIL STORE AND DEVICE THEREOF, AND COMPUTER READABLE STORAGE MEDIUM

(71) Applicant: Shenzhen Dorabot Inc., Shenzhen (CN)

(72) Inventor: YaoHuan Deng, Shenzhen (CN)

(21) Appl. No.: 16/571,577

(22) Filed: Sep. 16, 2019

(30) Foreign Application Priority Data
Sep. 20, 2018 (CN) CN201811102790.9

(51) Int. Cl. G06Q 10/08; B25J 9/16; B25J 11/00; H04W 4/35

(52) U.S. Cl. CPC G06Q 10/087; B25J 9/1697; H04W 4/35; B25J 11/008; B25J 9/1689

(57) ABSTRACT

The invention provides a controlling method of an unattended retail store and device thereof, and computer readable storage medium. The controlling method of the unattended retail store comprises the steps: obtaining a shelf data and a stacking data on a shelf via a visual identification device; determining whether to replenish goods based on the shelf data and the stacking data; controlling the robot to place the goods onto the corresponding shelf when it is determined that replenishment is required. The invention improves the efficiency and automation of the controlling of the unattended retail store.

### RELATED APPLICATION

This application claims priority to China Patent Application No. CN201811102790.9, filed on Sep. 20, 2018, and entitled “CONTROLLING METHOD OF UNATTENDED RETAIL STORE AND DEVICE THEREOF, AND COMPUTER READABLE STORAGE MEDIUM”, which is incorporated herein by reference in its entirety.

### FIELD OF THE INVENTION

The invention relates generally to the field of unattended retail store, and in particular to a controlling method of the unattended retail store and device thereof, and computer readable storage medium.

### BACKGROUND OF THE INVENTION

The unattended retail stores in the prior art are less efficient and less automated. The shelves in the shops are vacant until the store clerk performs manual replenishment after the customers buy the goods.

### SUMMARY OF THE INVENTION

The purpose of the invention is to provide a controlling method of the unattended retail store and device thereof, and computer readable storage medium, in order to improve the efficiency and automation of the unattended retail store.

In accordance with an aspect of the invention, a controlling method of the unattended retail store is provided. The method includes the following steps: obtaining a shelf data and a stacking data on a shelf via a visual identification device; determining whether to replenish goods based on the shelf data and the stacking data; controlling the robot to place the goods onto the corresponding shelf when it is determined that replenishment is required.

Preferably, the controlling method further includes the following steps: determining whether the surroundings of the unattended retail store has satisfied an expected condition that allows the goods to be adjusted before controlling the robot to enter a shopping area of the unattended retail store; controlling the robot to enter the shopping area of the unattended retail store to adjust the goods when the surroundings reach the expected condition.

Preferably, the controlling method further includes the following steps: adding the goods to a delivery queue of the robot of the corresponding shelf before controlling the robot to enter the shopping area of the unattended retail store; controlling the robot to adjust the goods on the basis of the delivery queue.

Preferably, the controlling method further includes the following steps: determining whether there is any goods stacked in a wrong position based on the shelf data and the stacking data; controlling the robot to pick up the wrong stacked goods and placing them in a preset position when it is found that the goods are stacked in the wrong position.

Preferably, the controlling method further includes the following steps: determining whether there is any goods located in a non-shelf area in the shopping area of the unattended retail store via the visual identification device; controlling the robot to pick up the goods in the non-shelf area and placing them into the preset position when there is goods located in the non-shelf area.

Preferably, the preset position is defined as the corresponding shelf of the goods; or the preset position is defined as a goods package station.

Preferably, the controlling method further includes the following steps: obtaining a first three-dimensional image with depth information via the visual identification device; obtaining a coordinate of the respective shelf and a coordinate of the robot on a retail store coordinate system based on the first three-dimensional image, and controlling the robot to move the goods onto the corresponding shelf based on the coordinates.

Preferably, the controlling method further includes the following steps: obtaining a second three-dimensional image with depth information by photographing via the visual identification device provided by the robot; obtaining a location data of the goods on a robot coordinate system based on the second three-dimensional image, and controlling the robot to acquire the goods based on the location data.

In accordance with another aspect of the invention, a controlling device for an unattended retail store is provided. The device includes a processor, a memory, and a controlling program stored on the memory and operable on the processor. The controlling program is executed by the processor to perform the steps of any one of the previously described controlling methods of the unattended retail store.

In accordance with yet another aspect of the invention, a computer readable storage medium is provided. The medium includes a controlling program of an unattended retail store stored therein. The steps of any one of the previously described controlling methods of the unattended retail store are performed when the controlling program of the unattended retail store is executed by a processor.

The controlling method of the unattended retail store and the device thereof, and the computer readable storage medium acquire the shelf data and the stacking data via the visual identification device to determine whether the replenishment of the goods is required. The robot places the goods onto the corresponding shelf when it is determined that replenishment is required. The unattended retail store implementing the methods according to the present invention needs less manpower, and the goods are intelligently replenished, thus efficiency is achieved.

### BRIEF DESCRIPTION OF THE DRAWINGS

FIG. 1 is a flow chart illustrating the controlling method of an unattended retail store according to the first embodiment of the present invention;

FIG. 2 is an application scenario of the controlling method of the unattended retail store shown in FIG. 1;

FIG. 3 is a partial flow chart illustrating the controlling method of an unattended retail store according to the second embodiment of present invention;

FIG. 4 is a partial flow chart illustrating the controlling method of an unattended retail store according to the third embodiment of present invention;

FIG. 5 is a partial flow chart illustrating the controlling method of an unattended retail store according to the fourth embodiment of present invention;

FIG. 6 is a partial flow chart illustrating the controlling method of an unattended retail store according to the fifth embodiment of present invention;

FIG. 7 is a partial flow chart illustrating the controlling method of an unattended retail store according to the sixth embodiment of present invention;

FIG. 8 is a partial flow chart illustrating the controlling method of an unattended retail store according to the seventh embodiment of present invention;

### DETAILED DESCRIPTION OF THE INVENTION

The invention will be described with reference to the accompanying drawings and the specifications. These and/or other aspects and advantages of the invention will become apparent and more readily appreciated from the following description of the embodiments, taken in conjunction with the accompanying drawings.

### The First Embodiment

The first embodiment of the present invention provides a controlling method of an unattended retail store.

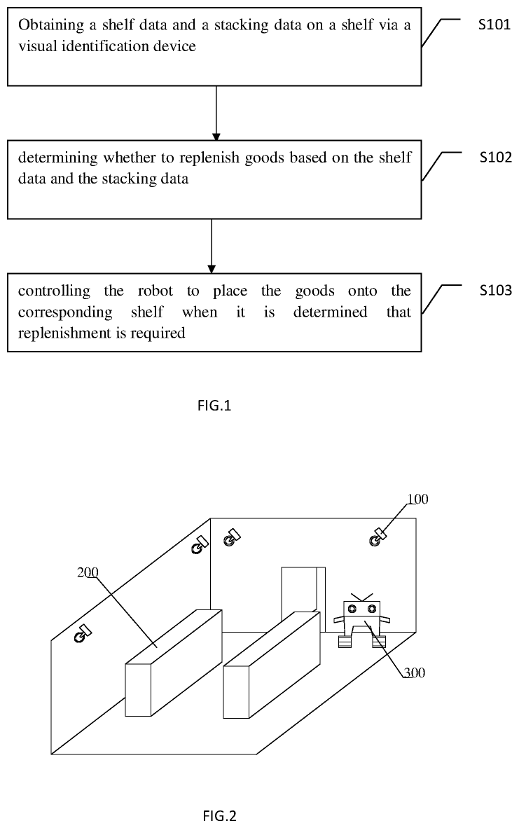

Referring generally to FIG. 1 and FIG. 2, the controlling method of an unattended retail store includes the following steps:

STEP S101, obtaining a shelf data and a stacking data on a shelf 200 via a visual identification device 100;

STEP S102, determining whether to replenish goods based on the shelf data and the stacking data;

STEP S103, controlling the robot 300 to place the goods onto the corresponding shelf 200 when it is determined that replenishment is required.

In the first embodiment, a shelf data and a stacking data on a shelf 200 are obtained via a visual identification device 100. The shelf data includes but not limited to the serial number of the shelf 200, the location of the shelf 200, and the layer height, the layer number, the column depth, and the column number of the shelf 200. In the embodiment, the three-dimensional visual data obtained by a visual device is configured to calculate the shelf data, such as the location and the shape of the shelf 200; alternatively, the shelf number is obtained by scanning via the visual device, then the pre-saved shelf data is searched based on the shelf number; the placement of the shelf 200 and the shelf data such as the layer height, the layer number, the column depth, and the column number of the shelf 200 are obtained based on the pre-saved shelf data; alternatively, the shelf data may be calculated by obtaining the three-dimensional visual data along with the pre-saved data.

The stacking data includes but not limited to the location of the goods, the serial number of the goods, the quantity of the goods, and the maximum quantity of items in the current column of the current shelf 200. In the embodiment, the stacking data such as the location of the goods, the quantity of the goods, the serial number of the goods, and the like is directly calculated via the visual device; the data of the goods is alternatively obtained based on the data of the corresponding shelf 200. For example, let's assume that AAA potato chips are placed in the first column and first layer of the shelf 200, the maximum quantity is 10 bags, the weight of each bag of AAA potato chip is 0.1 kg; the weight of AAA potato chips in the first column and first layer of the current shelf 200 is acquired based on the weighing function of the shelf 200; for example, it can be acquired that there are 5 bags of AAA potato chips in the first column of the first shelf on the current shelf 200 when the current measured weight is 0.5 kg. Of course, it is also possible to obtain the stacking data based on the visual data along with the shelf data. For example, we know that BBB instant noodles are placed on the second layer and second column of the shelf by scanning based on the visual data, the unit weight of the BBB instant noodles is obtained on the basis of the pre-saved data of the BBB instant noodles, then the total weight of the goods placed on the second column and the second layer can be required based on the weighing function of the shelf 200, thus it is known that how many boxes of BBB instant noodles are placed on the second column and second layer.

The visual identification device 100 includes a camera capable of obtaining three-dimensional images; alternatively includes a plurality of two-dimensional cameras to obtain two-dimensional images, and the three-dimensional images are obtained by calculation. Then, the three-dimensional images are input into a pre-trained neural network, in order to identify the shelf 200 and the goods, and then outputting the location data of the goods, and the goods data such as the shape of the goods, etc.

In the first embodiment, it is determined whether to replenish goods based on the shelf data and the stacking data after the shelf data and the stacking data on the shelf 200 are acquired. If the quantity of the stacked goods is less than the preset quantity, replenishment is required. It is assumed that replenishment is required when the goods is less than 20%, CCC chocolates are disposed on the first column to the fifth column of the third layer of the shelf 200, the first column is vacant, the second column is half full, the third column and the fifth column are full; it shows that 7/10 of the CCC chocolate remains in stock, in general, there is no need for replenishment, but CCC chocolate is needed to be added onto the first column of the shelf. Additional CCC chocolates from the inventory are placed onto the first column of the third layer, alternatively, CCC chocolates from the third column to the firth column are placed onto the first column of the third layer.

In the first embodiment, the robot 300 is controlled to place the goods onto the corresponding shelf 200 when it is determined that replenishment is required. The robot 300 is a humanoid robot 300, or may be a robot arm mounted on a track or the like. Moving the robot 300 to a preset position and when facing the corresponding shelf 200, the robot places the goods in their own positions. Specifically, the location of the robot relative to the corresponding shelf 200 is acquired via a sensor, then, the spatial location of the required goods is acquired on the basis of the preset data, and then the required goods is moved to the preset spatial location, thereby completing the replenishment. Alternatively, the robot 300 can calculate the positions of both the shelf 200 and the goods with respect to the robot itself by a depth camera provided by the robot 300, and then control the robot arm to place the goods, thus the goods are more intelligently replenished.

In the first embodiment, both the shelf data and the stacking data on a shelf 200 are obtained via the visual identification device 100 so as to determine whether replenishment is required, the robot 300 is controlled to place the goods onto the corresponding shelf 200 when it is determined that replenishment is required. Therefore, the unattended retail store according to the present invention needs less manpower, and goods are intelligently replenished, thus efficiency is achieved.

### The Second Embodiment

The second embodiment provides a controlling method of the unattended retail store. The second embodiment is based on the above embodiment, more flows are additionally added and illustrated as below.

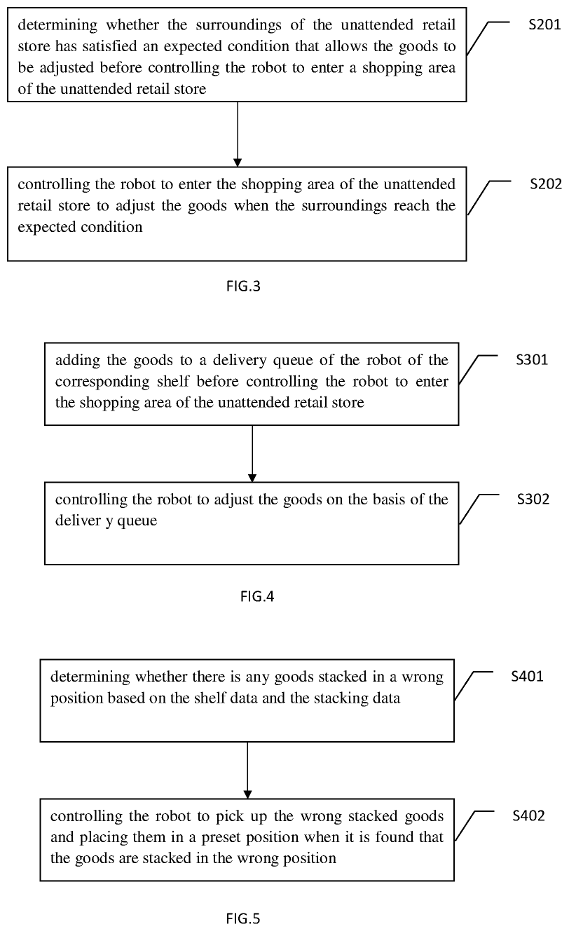

As shown in FIG. 3, the controlling method of the unattended retail store further includes the following steps:

STEP S201, determining whether the surroundings of the unattended retail store have satisfied an expected condition that allows the goods to be adjusted before controlling the robot to enter a shopping area of the unattended retail store;

STEP S202, controlling the robot to enter the shopping area of the unattended retail store to adjust the goods when the surroundings reach the expected condition.

In the second embodiment, it is determined whether the surroundings of the unattended retail store have satisfied the expected condition that allows the goods to be adjusted before controlling the robot to enter a shopping area of the unattended retail store. The robot stays in the preset parking area when it is not required to replenish the shelf 200 with the corresponding goods. The parking area is an area on the ground or an area located in the air depending on different types of the robot. When it is determined that some shelves need to be replenished, it is necessary to determine whether the shopping area corresponding to the shelf satisfies the conditions of surroundings. The conditions of surroundings are preset in advance according to expected conditions, for example, it is determined that the conditions of surroundings reach the expected conditions when the shopping area is vacant; alternatively, the conditions of surroundings reach the expected conditions, when the shopping area is vacant and no one is expected to arrive at the shopping area within 1 minute; or when the shopping area is vacant and it is in the preset period, for example, from 01:00 a.m. to 07:00 a.m.

In the second embodiment, the robot is controlled to enter the shopping area of the unattended retail store to adjust the goods when the surroundings reach the expected condition.

The second embodiment also includes the steps of the first embodiment and the effect of the process. Please refer to the foregoing embodiments for more details, and details are not described herein again.

As to the controlling method according to the second embodiment of the present invention provides, by determining whether the surroundings of the unattended retail store satisfies the preset conditions to allow the goods to be adjusted, and, the robot is controlled to enter the shopping area of the unattended retail store to adjust the goods only when the surroundings satisfy the preset conditions.

Of course, in other embodiments, the robots are smaller and slower compared with adults, the robots are alternatively arranged in the attended retail stores. The robot may plan a path based on the position of the shelf that needs to be adjusted. Then, carrying with the goods, the robot moves to the destination based on the path planning, and places the goods on a corresponding position of the shelf. While moving, by means of the 3D visual module provided by the robot or the pre-positioned 3D visual module located over the unattended retail store, detecting the customers in the robot moving direction and around the robot; the robot stops moving to ensure the safety of the customer when the customers are within the preset distance in the robot moving direction or when the customers are within the preset distance on the left and right sides of the robot.

### The Third Embodiment

The third embodiment provides a controlling method of the unattended retail store. The third embodiment is based on the above embodiments, more flows are additionally added and illustrated as below.

As shown in FIG. 4, the controlling method of the unattended retail store further includes the following steps:

STEP S301, the goods are added to a delivery queue of the robot of the corresponding shelf before controlling the robot to enter the shopping area of the unattended retail store;

STEP S302, the robot is controlled to adjust the goods on the basis of the delivery queue.

In the third embodiment, the goods are added to a delivery queue of the robot of the corresponding shelf before controlling the robot to enter the shopping area of the unattended retail store. When there is a plurality of shelves, each shelf corresponds to each robot, alternatively, several shelves correspond to one robot, so that the goods on the shelf are adjusted more efficiently. When a certain shelf in the shopping area needs to be replenished, it is not appropriate to send the robot immediately for the sake of safety or economy. Instead, the data of the goods that need to be replenished is added to the delivery queue. For example, the delivery queue of the robot A includes 1. AAA goods, 2. BBB goods, 3. CCC goods, 4. DDD goods, 5. EEE goods, and 6. FFF goods and so on within one hour. The delivery queue is sequenced based on time or the location of the shelf.

In the third embodiment, the robot adjusts the goods based on the delivery queue when the robot starts delivering. The robot delivers in order, for example, the robot firstly carries 1. AAA goods, and 2. BBB goods, and then replenishes to the corresponding shelves; then carries the 3. CCC goods for the second time, and then adds to the corresponding shelves . . . until the N times carries 6. FFF goods to the corresponding shelves.

The third embodiment also includes the steps of the first embodiment and the effect of the process. Please refer to the foregoing embodiments for more details, and details are not described herein again.

In the third embodiment, the goods are added to a delivery queue of the robot of the corresponding shelf before controlling the robot to enter the shopping area of the unattended retail store. The robot is controlled to adjust the goods on the basis of the delivery queue. This enables the robot to be centrally delivered, thereby more efficiently controlling the robot for delivery.

### The Fourth Embodiment

The fourth embodiment provides a controlling method of the unattended retail store. The fourth embodiment is based on the above embodiments, more flows are additionally added and illustrated as below.

As shown in FIG. 5, the controlling method of the unattended retail store further includes the following steps:

STEP S401, it is determined whether there is any goods stacked in a wrong position based on the shelf data and the stacking data;

STEP S402, the robot is controlled to pick up the wrong stacked goods and place them in the preset position when it is found that the goods are stacked in the wrong position.

In the fourth embodiment, it is determined whether there is any goods stacked in the wrong position based on the shelf data and the stacking data. The shelf data is obtained by scanning the shelf code; or obtaining the shelf location by scanning via the three-dimensional visual device, then the shelf data is obtained along with the preset map of the shelves. The stacking data is obtained according to the goods data obtained by means of the three-dimensional visual scanning. Along with the shelf data and the goods data, it is determined whether the goods are wrongly staked, for example, both AAA goods and other goods are disposed on a column of the shelf via the three-dimensional visual scanning; the scanning result is barcode identification or shape recognition. The shape recognition applies as below, for example: AAA goods are square shaped, but it is scanned that there is some round-shaped goods in the column of the shelf, or there is other goods stacked on the AAA goods. The barcode identification applies as below, for example: it is scanned that the label of certain column of the shelf corresponds to AAA goods, however, the goods in front of the shelf shows that they are BBB goods by scanning.

In the fourth embodiment, the robot is controlled to pick up the wrongly stacked goods and place them in the preset position when it is found that the goods are stacked in the wrong position. The preset position is a right position of the wrongly stacked goods, or it is a certain preset position, such as a cargo sorting station.

The fourth embodiment also includes the steps of the first embodiment and the effect of the process. Please refer to the foregoing embodiments for more details, and details are not described herein again.

In the fourth embodiment, it is determined whether there is any goods in a wrong stacked position based on the shelf data and the stacking data; the robot is controlled to pick up the wrong stacked goods and place them in the preset position when it is found that the goods are stacked in the wrong position. It makes it possible to adjust the wrongly stacked with automation and more efficiency.

### The Fifth Embodiment

The fifth embodiment provides a controlling method of the unattended retail store. The fifth embodiment is based on the above embodiments, more flows are additionally added and illustrated as below.

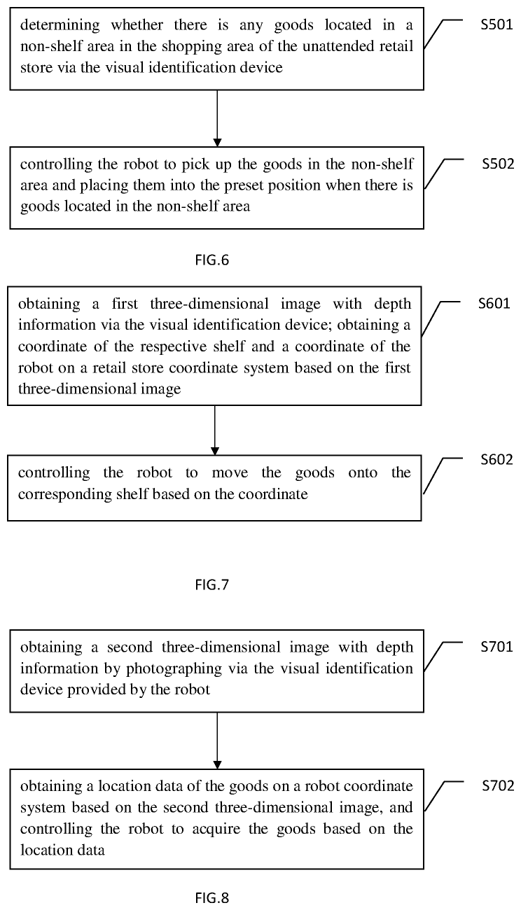

As shown in FIG. 6, the controlling method of the unattended retail store further includes the following steps:

STEP S501, it is determined whether there is any goods located in a non-shelf area in the shopping area of the unattended retail store via the visual identification device;

STEP S502, the robot is controlled to pick up the goods in the non-shelf area and place them into the preset position when there are goods located in the non-shelf area.

In the fifth embodiment, it is determined whether there are any goods located in a non-shelf area in the shopping area of the unattended retail store via the visual identification device. As mentioned above, the visual identification device refers to a camera capable of obtaining three-dimensional images; alternatively refers to a plurality of two-dimensional cameras to obtain two-dimensional images, and the three-dimensional images are obtained by calculation. The three-dimensional images are input into a pre-trained neural network, in order to identify the shelf and the goods, and then outputting the location data of the goods, and the goods data such as the shape of the goods, etc. If any goods are identified to be located in the non-shelf area, then it is determined there are goods located in the non-shelf area.

In the fifth embodiment, the robot is controlled to pick up the goods in the non-shelf area and place them into the preset position when it is determined that there are goods located in the non-shelf area. The robot moves to the goods location, and identifies the location of the goods via the visual identification module provided by itself, or identifies the goods location by means of the goods images acquired via the visual equipment disposed in the unattended retail store. In the embodiment, the preset position is a shelf position of the corresponding goods, or it is a cargo reorganizing station for reorganizing the goods.

The fifth embodiment also includes the steps of the first embodiment and the effect of the process. Please refer to the foregoing embodiments for more details, and details are not described herein again.

In the fifth embodiment of the present invention, it is determined whether there are any goods located in the non-shelf area in the shopping area of the unattended retail store via the visual identification device; then the robot is controlled to pick up the goods on the non-shelf area and place them onto the preset position when there are goods located in the non-shelf area. Thereby, it is possible to manage the goods dropped in the unattended retail store automatically, avoiding manual processing, thus improving the automation, and promoting the efficiency.

### The Sixth Embodiment

The sixth embodiment provides a controlling method of the unattended retail store. The sixth embodiment is based on the above embodiments, more flows are additionally added and illustrated as below.

As shown in FIG. 7, the controlling method of the unattended retail store further includes the following steps:

STEP S601, a first three-dimensional image with depth information is obtained via the visual identification device;

STEP S602, a coordinate of the respective shelf and a coordinate of the robot on a retail store coordinate system are obtained based on the first three-dimensional image, and the robot is controlled to move the goods onto the corresponding shelf based on the coordinates.

In the embodiment, a first three-dimensional image with depth information is obtained via the visual identification device. As mentioned above, the visual identification device includes a camera capable of obtaining three-dimensional images; alternatively includes a plurality of two-dimensional cameras to obtain two-dimensional images, and the three-dimensional images are obtained by calculation. Then, the three-dimensional images are input into a pre-trained neural network, in order to identify the shelf and the goods, also output the location data of the goods, and the goods data such as the shape of the goods, etc. A plurality of visual identification devices are disposed on different locations of the unattended retail store, and then, the three-dimensional images are obtained by image merging.

In the embodiment, after the first three-dimensional image is obtained, a coordinate of the respective shelf and a coordinate of the robot on a retail store coordinate system are obtained based on the first three-dimensional image, and the robot is controlled to move the goods onto the corresponding shelf based on the coordinates. As the shelves are usually kept in place for a long time after they are put in place, the coordinates of the shelves can reduce the frequency of calculating positions of the shelves. When the data of the moving robot is obtained, it is necessary to calculate the positions data and shape data of the robot at a higher frequency. Thereby, the robot is controlled to move. If the robot moves based on path planning, it is possible to prevent the robot from colliding with the obstacle in the process of moving by calculating the position data and the shape data of the robot in real time. The obstacle is a shelf, a cargo, or a shopper, and the like.

The sixth embodiment also includes the steps of the first embodiment and the effect of the process. Please refer to the foregoing embodiments for more details, and details are not described herein again.

In the sixth embodiment of the present invention, the first three-dimensional image with depth information is obtained via the visual identification device, the coordinate of the respective shelf and the coordinate of the robot on the retail store coordinate system are obtained based on the first three-dimensional image, and the robot is controlled to move the goods onto the corresponding shelf based on the coordinates. Thus, the robot is more accurately controlled in the unattended retail store, and the control is more precise and safer.

### The Seventh Embodiment

The seventh embodiment provides a controlling method of the unattended retail store. The seventh embodiment is based on the above embodiments, more flows are additionally added and illustrated as below.

As shown in FIG. 8, the controlling method of the unattended retail store further includes the following steps:

STEP S701, a second three-dimensional image with depth information is obtained by photographing via the visual identification device provided by the robot;

STEP S702, a location data of the goods on a robot coordinate system is obtained based on the second three-dimensional image, and the robot is controlled to acquire the goods based on the location data.

In the embodiment, a second three-dimensional image with depth information is obtained by photographing via the visual identification device provided by the robot. As mentioned above, the visual identification device includes a camera capable of obtaining three-dimensional images; alternatively includes a plurality of two-dimensional cameras to obtain two-dimensional images, and the three-dimensional images are obtained by calculation. Then, the three-dimensional images are input into a pre-trained neural network, in order to identify the shelf and the goods, also output the location data of the goods, and the goods data such as the shape of the goods, etc. The robot itself is provided with a computing module to recognize the three-dimensional image; alternatively, the robot sends the data to a server in the retail store, and then the result is sent back to the robot after the calculations of the server.

In the embodiment, after the second three-dimensional image is obtained, a location data of the goods on a robot coordinate system is obtained based on the second three-dimensional image, and the robot is controlled to acquire the goods based on the location data. The data of the shelves and that of the goods are included in the second three-dimensional image. After being calculated by the neural network, the system is able to recognize the shelves and the goods, and obtain the depth information of the goods and that of the shelves, thereby controlling the robot arm to move a corresponding distance in the direction of the target to achieve the grasping or releasing of the goods. While grabbing the goods, we know whether the grabbing is successful or not via the second three-dimensional image.

The seventh embodiment also includes the steps of the first embodiment and the effect of the process. Please refer to the foregoing embodiment for more details, and details are not described herein again.

In the seventh embodiment of the present invention, the second three-dimensional image with depth information is obtained by photographing via the visual identification device provided by the robot, then the location data of the goods on the robot coordinate system is obtained based on the second three-dimensional image, and the robot is controlled to acquire the goods based on the location data. Thus, the robot grasps and places the goods more accurately and efficiently.

### The Eighth Embodiment

The eighth embodiment provides a controlling device for the unattended retail store.

The controlling device for the unattended retail store comprises: a processor, a memory, and a controlling program stored on the memory and operable on the processor, the controlling program is executed by the processor to perform the steps of the controlling method of the unattended retail store according to any one of the above embodiments.

The eighth embodiment includes all the technical features in the above-mentioned controlling methods, the present embodiment also has the advantageous effects of the above-mentioned controlling methods. Please refer to the foregoing embodiments for more details, and details are not described herein again.

### The Ninth Embodiment

The ninth embodiment provides a computer readable storage medium.

A controlling program of an unattended retail store is stored in the computer readable storage medium, the steps of the controlling method of the unattended retail store in any one of the above-mentioned embodiments are performed when the controlling program of the unattended retail store is executed by a processor.

The ninth embodiment includes all the technical features in the above-mentioned controlling methods, the present embodiment also has the advantageous effects of the above-mentioned controlling methods. Please refer to the foregoing embodiments for more details, and details are not described herein again.

It is to be understood that the terms “comprises”, “comprising”, or any other variants thereof, are intended to encompass a non-exclusive inclusion, thus a process, method, article, or device comprising a series of elements includes not only those elements, but also includes other elements that are not explicitly listed, or elements that are inherent to such a process, method, article, or device. An element that is defined by the phrase “comprising a . . . ” does not exclude the presence of additional equivalent elements in the process, method, item, or device that comprises the element.

The serial numbers in the embodiments of the present invention are merely for the descriptions, not representing the advantages or disadvantages of the embodiments.

With the descriptions of the above embodiments, those skilled in the art clearly understand that the methods in the foregoing embodiments are implemented by means of software along with a necessary and general hardware platform, and of course, a hardware is alternatively included, but in most cases, the former is better. Based on such understanding, the technical solutions of the present invention, that is, the essential contributions compared with the prior art, are embodied in the form of a software product stored in the storage medium (such as a ROM/RAM, or a disk, or the compact disc), and includes a number of instructions for enabling a terminal (such as a cell phone, or a computer, or a server, or an air conditioner, or a network device, etc.) to perform the methods described in various embodiments of the present invention.

The invention is described with reference to the accompanying drawings and the specifications. These and/or other aspects and advantages of the invention will become apparent and more readily appreciated from the following description of the embodiments, taken in conjunction with the accompanying drawings. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A controlling method of an unattended retail store, comprising the steps:
obtaining a shelf data and a stacking data on a shelf via a visual identification device;
determining whether to replenish goods based on the shelf data and the stacking data;
controlling the robot to place the goods onto the corresponding shelf when it is determined that replenishment is required.

2. The controlling method as defined in claim 1, wherein further comprises the steps: determining whether the surroundings of the unattended retail store has satisfied an expected condition that allows the goods to be adjusted before controlling the robot to enter a shopping area of the unattended retail store; controlling the robot to enter the shopping area of the unattended retail store to adjust the goods when the surroundings reach the expected condition.

3. The controlling method as defined in claim 1, wherein further comprises the steps: adding the goods to a delivery queue of the robot of the corresponding shelf before controlling the robot to enter the shopping area of the unattended retail store; controlling the robot to adjust the goods on the basis of the delivery queue.

4. The controlling method as defined in claim 1, wherein further comprises the steps: determining whether there is any goods stacked in a wrong position based on the shelf data and the stacking data; controlling the robot to pick up the wrong stacked goods and placing them in a preset position when it is found that the goods are stacked in the wrong position.

5. The controlling method as defined in claim 4, wherein the preset position is defined as the corresponding shelf of the goods; or the preset position is defined as a goods package station.

6. The controlling method as defined in claim 1, wherein further comprises the steps: determining whether there is any goods located in a non-shelf area in the shopping area of the unattended retail store via the visual identification device; controlling the robot to pick up the goods in the non-shelf area and placing them into the preset position when there is goods located in the non-shelf area.

7. The controlling method as defined in claim 6, wherein the preset position is defined as the corresponding shelf of the goods; or the preset position is defined as a goods package station.

8. The controlling method as defined in claim 1, wherein further comprises the steps: obtaining a first three-dimensional image with depth information via the visual identification device; obtaining a coordinate of the respective shelf and a coordinate of the robot on a retail store coordinate system based on the first three-dimensional image, and controlling the robot to move the goods onto the corresponding shelf based on the coordinates.

9. The controlling method as defined in claim 8, wherein further comprises the steps: obtaining a second three-dimensional image with depth information by photographing via the visual identification device provided by the robot; obtaining a location data of the goods on a robot coordinate system based on the second three-dimensional image, and controlling the robot to acquire the goods based on the location data.

10. A controlling device for an unattended retail store, comprising: a processor, a memory, and a controlling program stored on the memory and operable on the processor, wherein the controlling program is executed by the processor to perform the steps of the controlling method of the unattended retail store according to claim 1.

11. A computer readable storage medium, comprising: a controlling program of an unattended retail store is stored in the computer readable storage medium, the step of the controlling method of the unattended retail store as claimed in claim 1 is performed when the controlling program of the unattended retail store is executed by a processor.
